(19) United States
(12) Patent Application Publication
(10) Pub. No.: US 2017/0145543 A1
(43) Pub. Date: May 25, 2017

(54) Manganese Ore Beneficiation Process

(71) Applicant: Samancor Manganese (Proprietary) Limited, Johannesburg (ZA)

(72) Inventor: Johannes Theodorus Ferreira LE ROUX, Alberton (ZA)

(21) Appl. No.: 15/318,993

(22) PCT Filed: Jun. 17, 2015
(86) PCT No.: PCT/IB2015/054574

§ 371 Date: Dec. 15, 2016

(30) Foreign Application Priority Data
Jun. 17, 2014 (ZA) 2014/04408

(51) Int. Cl. C22B 47/00; C01F 5/02; C22B 3/06; C01F 11/02; C22B 1/24; C22B 3/10

(52) U.S. Cl. CPC C22B 47/00; C22B 1/24; C22B 3/10; C22B 3/065; C01F 11/02; C01F 5/02

(57) ABSTRACT

A process for the beneficiation of Manganese ore which includes the step of leaching of the ore with acid to remove Calcium Carbonate and Magnesium Carbonate. The ore is first broken down to the required particle size by conventional means. Selective leaching of Calcium oxide and Magnesium carbonate occurs leaving an ore having a higher Manganese content.

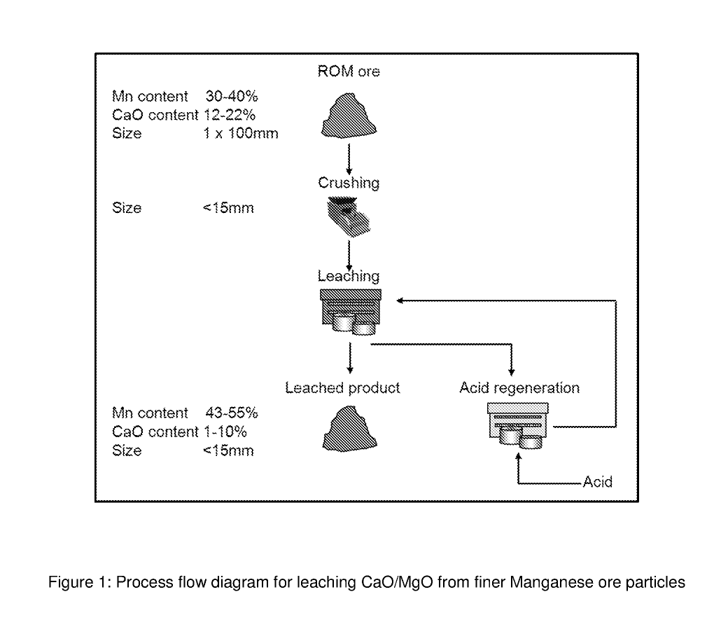

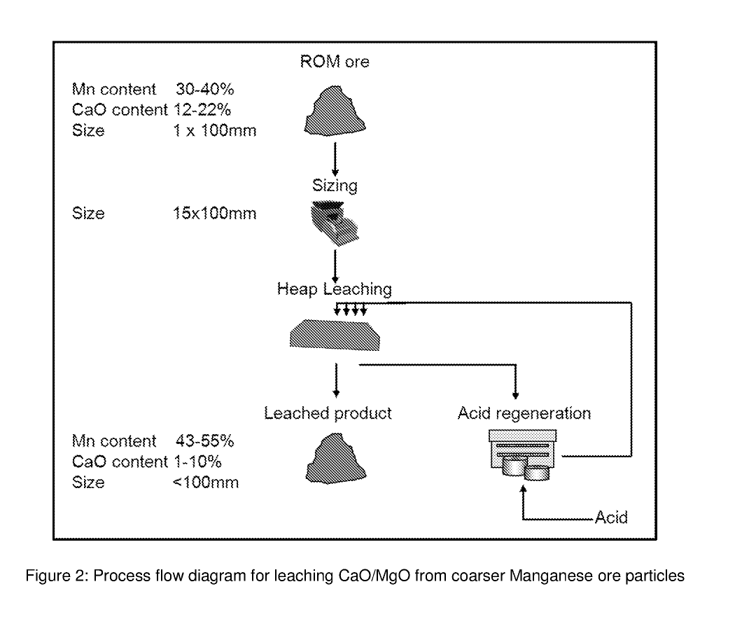

This invention relates to the processes used in the beneficiation of Manganese ore.

### FIELD OF THE INVENTION

The invention is in the field of processes used in the beneficiation of Manganese ore.

### BACKGROUND TO THE INVENTION

Various methods have been used in the past for the beneficiation of Manganese ore to upgrade the Manganese content in the ore and thereby improving its quality and value.

These methods include crushing, milling, washing and dense media separation. The product that is yielded from these processes is normally fine and these fine particles need to be agglomerated, typically by sintering, to form a coarser product to assist with the production of Manganese alloys when used in submerged arc furnaces.

A further process of beneficiation of Manganese includes the milling of the Manganese ore, followed by reduction in a kiln, and thereafter leaching with sulphuric acid and electroplating. This process has been successfully carried out and produces a Manganese metal product which is of a high Manganese quality, typically 98% Mn. The aim of this leaching process is to target the sought after mineral, ie Manganese in this case, leach it out and treat it to recover it in a concentrated format.

The disadvantage of this process is primarily centred on the transport of ore from the mine area. Transport is charged by weight and/or volume and typically the manganese beneficiation process takes place not on the mine, but on the premises of the purchaser thereof. The result is that low grade manganese ore must be transported by railway and ship to its final destination.

In this application however, a process is described whereby CaO and MgO (in the form of calcium carbonate and magnesium carbonate), two major impurities of the ore, are selectively leached out, leaving a higher concentration of manganese in the ore. As 50-60% of the world's manganese resources have a high CaO/MgO (in carbonate form) content, the proposed process has significant advantages.

In this application, the CaO/MgO content of the ore can be significantly reduced prior to transport, resulting in a significant reduction in the mass and volume of ore to be transported and a concomitant cost reduction.

In this application when a reference is made to CaO or MgO content, the actual minerals containing these components are CaOCO₂ or MgOCO₂ or CaMg(CO₃)₂ or Kutnahorite or a combination of them.

### SUMMARY OF THE INVENTION

According to a first aspect of the invention there is provided a process for the beneficiation of Manganese ore, the process including the leaching of the ore with acid to remove CaCO₃ (Calcium carbonate) and MgCO₃ (Magnesium carbonate).

The ore may be broken down by various suitable means including but not limited to crushing, milling, washing and/or dense media separation. An ore product is yielded which is then leached. The ore product may be of varying sizes which are suitable for effective leaching of CaO/MgO from the ore. The ore product may comprise a particle size of less than 100 mm in diameter.

Leaching may occur in various ways including VAT leaching, CSTR (continuous stirred-tank reactor) and/or heap leaching. These leaching processes may occur in a batch process or a continuous process.

During leaching an acid may be added to the ore product. This acid may be any suitable acid which will assist with the leaching of CaO/MgO from the ore. The acid may be any one or more of the group including hydrochloric acid, nitric acid, and the like. The acid used in leaching may include a combination of two or more acids. The concentration of the acids may vary to ensure adequate leaching of CaO/MgO from the ore, and each acid may have a concentration of between 0.1% and 100%.

The time taken for leaching of the ore to occur may vary, depending on various factors including any one or more of the group including the temperature at which the leaching process is carried out; the concentration of the acids used in leaching process; the ratio of ore to acid used in the leaching process; agitation of the ore and liquid during the leaching process and the ore size used in the leaching process.

The leached ore product may include varying percentages of Manganese in relation to CaO/MgO, in the ore. CaO and MgO is selectively leached out of the ore product and provides an ore with a high Manganese concentration.

Acid used in the leaching process may be regenerated by various means.

According to a further aspect of the invention there is provided a process for the beneficiation of Manganese ore, the process including the steps of:

breaking Calcium/Magnesium carbonate (CaCO₃/MgCO₃) rich Manganese ore into a finer ore product having a diameter of between 1 mm and 100 mm; and leaching the ore with acid to remove CaCO₃ and MgCO₃.

### DESCRIPTION OF THE INVENTION

The invention will now be described with reference to the following non-limiting example.

The process for beneficiation of Manganese Ore includes providing Manganese Ore which is rich in Calcium carbonate (CaCO₃) and Magnesium carbonate (MgCO₃). In one embodiment of the invention, a Manganese Ore comprising 30-40% Manganese content and a 12-22% CaO content (the ore product with a size of approximately 100 mm per particle) is crushed. This product is high in CaO and MgO concentration.

The crushing of the ore product will provide a finer ore product which is then leached.

During leaching acid is added to the fine ore product. Leaching takes place by means of vat leaching and/or CSTR leaching and/or heap leaching, and these processes can be either as a batch process or a continuous process. The acid used in this process can vary, but can be hydrochloric acid and/or nitric acid. The acid used can be a combination of two or more acids at differing concentrations.

Leaching occurs at a temperature and for a length of time which ensures that an ore with a high Manganese concentration is the resultant product.

During leaching the acid added to the fine ore product will selectively leach the CaO and MgO from the fine ore product and allow for the Manganese to remain.

The leached fine ore product includes a Manganese content of 40-52% and a CaO content of 1-10%. This shows an ore product with a sufficiently decreased CaO content and with a high quality Manganese content in the Ore.

The invention therefore provides a novel process for the beneficiation of Manganese ore.

### TEST RESULTS The invention is illustrated and exemplified by way of the following non-limiting tests and examples.

Three types of tests were conducted namely laboratory scale, mini-plant VAT leaching and 1 metre column leaching to illustrate heap leaching capability.

### Test 1—Laboratory Scale

Laboratory scale test work was carried out on 1×9 mm Mamatwan fines to illustrate the method. Variables tested included processing time, concentration and solid to liquid ratio.

Mamatwan ore is representative of the high Calcium carbonate and Magnesium carbonate ore, sourced from Mamatwan mine.

CaO reduces from 17% to less than 2%. The % on the graph relates to the % acid concentration used to achieve the upgrade, ranging from 2.5% to 32% hydrochloric acid.

Results obtained illustrated the following regarding the variables tested:

Time—at a constant concentration leaching (upgrading) is completed within 2 hours.

Concentration—concentration was varied from 2.5% up to 32% with significant improvement of Mn content up to 52% from 36.5%. This was achieved with 20% HCl acid. The resultant CaO content was reduced from 17% to as low as 1%.

Solid/liquid ratio—(red triangles) at a constant concentration any solid:liquid ratio above 1:>1 yields the same upgrading. All future test were conducted at a solid:liquid ratio of 1:2

### Test 2—VAT Leaching on a Mini-Plant Scale

### Test 2a)—1×15 mm Mamatwan Type Ore

Several tests were conducted on Mamatwan type ore (1×15 mm size fraction) with elemental analysis (as shown in column 1) of Mn and CaO content of 36.5% and 16.8% respectively. A VAT type leach reactor operating at 20 degrees Celsius was used for 200 kg batch sizes with approximately 400 litres of acid.

The tabulated results refer specifically to the 1×15 mm size fraction:

The following variables were tested during the different campaigns with HCl (hydrochloric acid):
1. Time (column 2+3)—conclusion is that the majority of the upgrade is done within 2 hours of introducing the ore to the acid (lixiviant) at 5% HCl concentration. The Mn increases from 36.5% to 40.5% with a mass recovery of 83-84% and a Mn recovery of 93%. The CaO has been reduced from 16.8% to 13%.
2. Agitation (column 4)—Agitation did not improve the Mn recovery nor the mass recovery of the leached product. At this scale (200 kg/batch) it seems agitation enhances the leaching of Mn in conjunction with CaOCO₃.
3. Temperature (column 5)—the initial temperature was increased from 20° C. to 44° C., but no real improvement has been observed in terms of Mn or mass recovery.
4. Acid concentration (column 6) was observed. At this scale (200 kg/batch) and acid concentration of 10%, significant improvement in resultant Mn content of the product was observed, increasing from 36.5% to 43.9%, although the mass recovery was only 73% and Mn recovery 88%. The CaO was reduced from 16.8% to 10.5% in the resultant ore.

Tests were also conducted with a different acid, ie HNO3 (nitric acid):—tests were conducted with 5% HNO3 and 10% HNO3. Although the mass recovery was similar to the HCl tests at the same concentrations, the Mn was lower at 88% and 83% vs 93% and 88% respectively for 5% and 10% acid.

### Test 2b)—Fine Mamatwan Ore and Lower Grade Mamatwan Discard Ore

Several tests were conducted on finer Mamatwan type ore with elemental analysis as in the first column, Mn 35.5% and CaO 17.4% in a VAT type reactor. The table below refers specifically to the 0×6 mm size fraction.

The following variables were tested during the different campaigns with HCl (Hydrochloric acid):
1. Time (column 2+3)—conclusion is that the majority of the upgrade is done within 2 hours of introducing the ore to the acid (lixiviant) at 5% HCL concentration. The Mn increases from 36.5% to 38-39% with a mass recovery of 80% and a Mn recovery of 86%. The CaO has been reduced from 17.4% to 14.2%.
2. Agitation (column 4)—Agitation did not improve the Mn recovery nor the mass recovery of the leached product. At this scale (200 kg/batch) it seems agitation enhances the leaching of Mn in conjunction with CaOCO₃.
3. Acid concentration (column 5)—the concentration was increased from 5% to 10% with a little improvement in the resultant Mn content, increasing from 35.5% to 39.7%, although the mass recovery was only 75% and Mn recovery 83%. The CaO was reduced from 17.4% to 12.9% in the resultant ore.

Tests were also tests conducted with two discard products from the DMS plant, with two different Mn grades as can be seen in column 6 and 8. The ore with a size of 1×15 mm was treated with 10% HCl in a VAT type reactor:
1. 31.5% Mn discard ore (column 6+7)—Tests were conducted for two hours at 10% acid and the Mn increased from 31.5% to 40.95, while the CaO content decreased from 22.3% to 13.6%. This with a mass recovery of 66% and Mn recovery of 86%.
2. Mn discard ore (column 8+9)—tests were conducted for two hours at 10% acid and the Mn increased from 29.7% to 35.6%, while the CaO content decreased from 23.7% to 17.4%. This with a mass recovery of 68% and a Mn recovery of 81%.

### Test 2c)—Mamatwan Lumpy Type Ore

The lumpy ore from Mamatwan type ore was also leached in a VAT type reactor with HCl testing processing time and concentration of acid.

The results achieved are stated below:
1. Time (column 1-5)—the time was varied from 2 to 24 hours with mixed results. On average the Mn increased from 36.7% to 39%, while the CaO reduced from 15.3% to 12%. The mass recovery was between 72% and 78% while the Mn recovery was between 72% an 86%.
2. Concentration (column 6)—the concentration was increased from 5% to 10%, but the Mn only increased from 36.7% to 39%, while the CaO reduced from 15.3% to 13.5%. The mass recovery was 79% and the Mn recovery 84%.

A lower grade Mamatwan ore was selected to conduct heap leach tests on. Time and concentration was tested with successful upgrading of the Mn content. A 1 metre high column was used with a 300 mm diameter.

### Test 3—Heap Leach Tests in a 1 Metre Column With 32% Mamatwan Type Lumpy Ore

3 heap leap tests were conducted in a 1 m column design of 300 mm diameter. The size fraction was 6×75 mm.

HL2—the test was conducted with 5% HCl acid circulating the acid for 2.75 days

HL3—the test was conducted with 10% HCl acid circulating the acid for 4.25 days

HL4—the test was conducted with 10% HCl acid circulating the acid for 11 days

HL1 refers to the original ore with no leaching applied to it.

The results of this heap leaching process are shown in the table below:

HL2—the Mn was upgraded from 32% to 34.3% and the CaO was reduced from 19.4% to 16.4%. The mass recovery was 85% and the Mn recovery 91%.

HL3—the Mn was upgraded from 32% to 33.6% and the CaO was reduced from 19.4% to 16.0%. The mass recovery was 72% and the Mn recovery 75%.

HL4—the Mn was upgraded from 32% to 40% and the CaO was reduced from 19.4% to 10.7%. The mass recovery was 69% and the Mn recovery 86%.

1. A process for the beneficiation of Manganese ore, comprising leaching of the ore with acid to remove CaCO₃ (Calcium carbonate) and MgCO₃ (Magnesium carbonate).

2. The process according to claim 1, wherein the ore is first broken down by one or more processes comprising crushing, milling, washing and dense media separation.

3. The process according to claim 1, wherein the ore has a particle size smaller than 100 millimetres in diameter.

4. The process according to claim 1, wherein leaching occurs by means of VAT leaching.

5. The process according to claim 1, wherein leaching occurs by means of continuous stirred tank reactor leaching.

6. The process according to claim 1, wherein leaching occurs by means of heap leaching.

7. The process according to claim 1, wherein the leaching process is a batch process.

8. The process according to claim 1, wherein the leaching process is a continuous process.

9. The process according to claim 1, wherein the process includes agitation of the acid and the ore.

10. The process according to claim 1, wherein the acid comprises hydrochloric acid.

11. The process according to claim 1, wherein the acid comprises nitric acid.

12. The process according to claim 1, wherein the acid comprises a combination of one or more of hydrochloric acid and nitric acid.

13. The process according to claim 10, wherein the acid concentration is in the range 0.1% to 100%.

14. The process according to claim 13, wherein the acid concentration is in the range 1% to 35%.

15. The process according to claim 14, wherein the hydrochloric acid concentration is in the range 2.5% to 32%.

16. The process according to claim 11, wherein the nitric acid concentration is in the range 5% to 10%.

17. The process according claim 1, wherein a Manganese content of the ore subjected to the process increases by between 5% and 30%.

18. The process according to claim 1, wherein a Calcium Oxide content of the ore decreased by up to between 16% in absolute terms and 94% in relative terms.

19. The process according to claim 1, wherein a Magnesium Oxide content of the ore decreased by up to 2.1% in absolute terms and 72% in relative terms.
